(19) United States
(12) Patent Application Publication
(10) Pub. No.: US 2017/0082170 A1
(43) Pub. Date: Mar. 23, 2017

(54) DAMPER APPARATUS FOR ALTERNATOR PULLEY

(71) Applicant: HYUNDAI MOTOR COMPANY, Seoul (KR)

(72) Inventor: Wan Soo OH, Yongin-si (KR)

(73) Assignee: HYUNDAI MOTOR COMPANY, Seoul (KR)

(21) Appl. No.: 14/951,712

(22) Filed: Nov. 25, 2015

(30) Foreign Application Priority Data
Sep. 17, 2015 (KR) 10-2015-0131510

(51) Int. Cl. F16F 15/14; F16H 55/36

(52) U.S. Cl. CPC F16F 15/1457; F16H 55/36; F16H 2055/366

(57) ABSTRACT

A damper apparatus for an alternator pulley uses a mass inertia body installed on a same axis as the alternator pulley to promote absorption of vibrations and removal of noises occurring due to a resonance of the alternator.

### CROSS-REFERENCE TO RELATED APPLICATION

The present application claims priority to Korean Patent Application No. 10-2015-0131510, filed Sep. 17, 2015, the entire contents of which is incorporated herein for all purposes by this reference.

### FIELD

The present disclosure relates to a damper apparatus for an alternator pulley, and more particularly, to technology for a damper apparatus capable of absorbing vibrations and noises occurring due to a resonance of the alternator.

### BACKGROUND

Generally, an alternator of a vehicle is provided along with an engine, to supply electric energy to electric loads of the vehicle. The alternator always has to maintain appropriate power to satisfy a correlation between the total electric load of the vehicle and the charging and discharging performance of a battery in every condition.

The alternator is driven by power supplied from a crank shaft. To this end, as illustrated in FIG. 1, an alternator pulley 1 is connected to a crank shaft pulley 5, together with a water pump pulley 2, an air conditioner pulley 3, a power steering pulley 4, etc., via a belt 6.

Reference number 7 is a tensioner pulley controlling a tension of the belt 6.

The alternator is driven by power supplied from the crank shaft. FIGS. 2 and 3 schematically illustrate that the alternator pulley 1 and the crank shaft pulley 5 are connected to each other via the belt 6.

FIG. 2 illustrates a solid type alternator in which the alternator 10 and the alternator pulley 1 are connected to each other by a shaft 11, which is a rigid body. FIG. 3 illustrates a low stiffness type alternator in which a low stiffness spring 13 and a clutch (not illustrated) assembly, instead of a rigid body shaft, are applied.

In the solid type alternator, vibrations of the belt 6 are increased due to a resonance of the alternator upon idling, such that a slip phenomenon of the belt 6 may occur.

To prevent this problem, a tension of the belt 6 is increased in the solid type alternator. In this case, however, a new disadvantage occurs, in that fuel efficiency is reduced.

Compared to the solid type alternator, the low stiffness type alternator has an advantage in that the vibrations of the belt 6 due to the resonance of the alternator upon the idling are small and the slip of the belt 6 is reduced, thus improving durability and fuel efficiency. But the low stiffness type alternator has disadvantages in that a subharmonic vibration occurs due to non-linearity of the low stiffness spring 13, and costs are greatly increased due to a use of the clutch.

The contents described as related art have been provided only for assisting in the understanding for the background of the present disclosure and should not be considered as corresponding to related art known to those skilled in the art.

### SUMMARY

An object of the present disclosure is to provide a damper apparatus for an alternator pulley, the damper apparatus capable of absorbing and reducing vibrations occurring due to a resonance of the alternator, by installing, on the same axis as the alternator pulley, a damper configured to generate a counter-torque to a torque of the alternator, thereby reducing noises and improving fuel efficiency.

A damper apparatus for an alternator pulley comprises: a mass inertia body configured to be disposed on a same axis as an alternator shaft while being positioned at a front side of the alternator pulley; and an elastic mechanism configured to connect the alternator pulley and the mass inertia body and to deliver an inertial rotating force of the mass inertia body to the alternator pulley while delivering a rotating force of the alternator pulley to the mass inertia body.

The damper apparatus may further include a bearing configured to: be installed between the alternator pulley and the mass inertia body; regulate an installation position of the mass inertia body; and block delivery of the rotating forces between the alternator pulley and the mass inertia body.

A rotating center of the mass inertia body and a mass center of the mass inertia body may coincide with each other, and an axial center of the alternator shaft and the rotating center of the mass inertia body may be configured to coincide with each other.

A front surface of the alternator pulley may be provided with a concave groove, some of the mass inertia body may be configured to be inserted into the concave groove, and the bearing may be configured to be installed in the concave groove between an inner circumferential surface of the concave groove and an outer circumferential surface of the mass inertia body.

The mass inertia body may include: an adaptor configured to be inserted into the concave groove to be connected to the alternator pulley by the bearing, and configured to be coupled with one end of an elastic mechanism; and a mass body configured to be coupled with a front of the adaptor.

The elastic mechanism may be a torsion spring having an end configured to be coupled with the alternator pulley and an end configured to be coupled with the adaptor.

The alternator shaft may penetrate through a rotating center of the alternator pulley, and an end of the alternator shaft penetrating through the alternator pulley may be coupled with a nut to couple the alternator pulley with the alternator shaft.

### DRAWINGS

FIG. 1 is a diagram describing a belt pulley system of a vehicle.

FIGS. 2 and 3 are diagrams describing a solid type alternator and low stiffness type alternator.

FIGS. 4 is a perspective view of a portion where a damper apparatus for an alternator pulley is installed, and

FIG. 5 is a cross-sectional view of a portion where a damper is installed.

### DETAILED DESCRIPTION

Hereinafter, a damper apparatus for an alternator pulley according to exemplary forms of the present disclosure will be described with reference to the accompanying drawings.

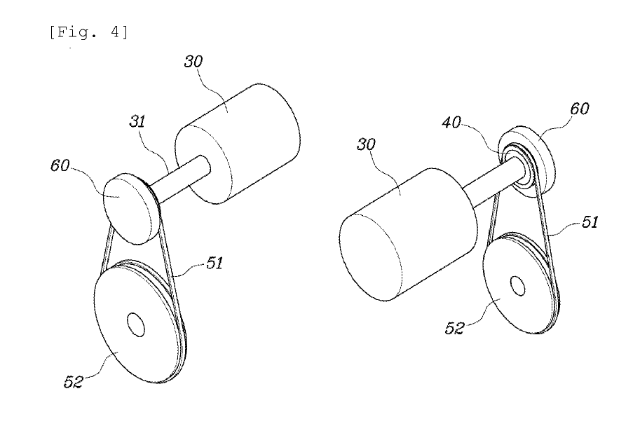

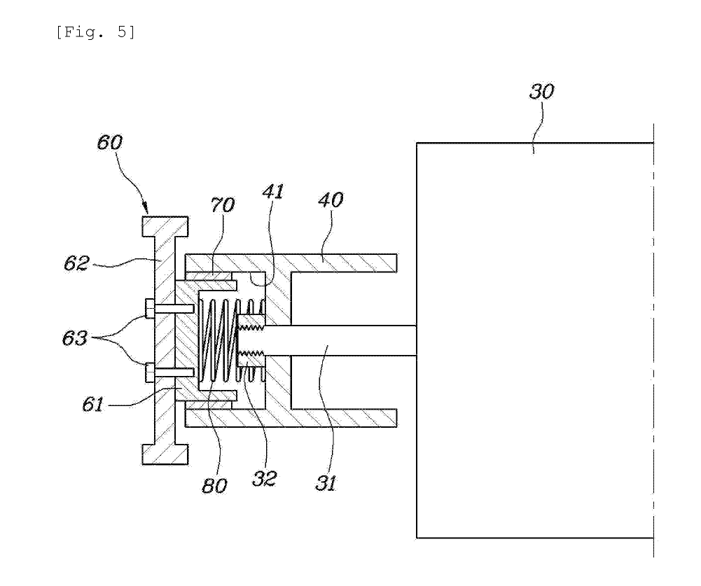

As illustrated in FIGS. 4 and 5, an alternator 30 is connected to an alternator pulley 40 by a shaft 31, the alternator pulley 40 is connected to a crank shaft pulley 52 by a belt 51, and a crank shaft pulley 52 is coupled with the damper apparatus.

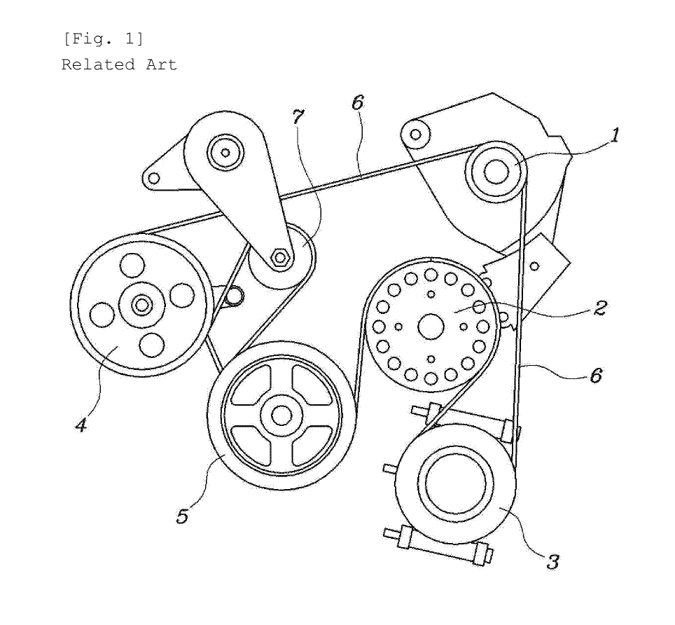

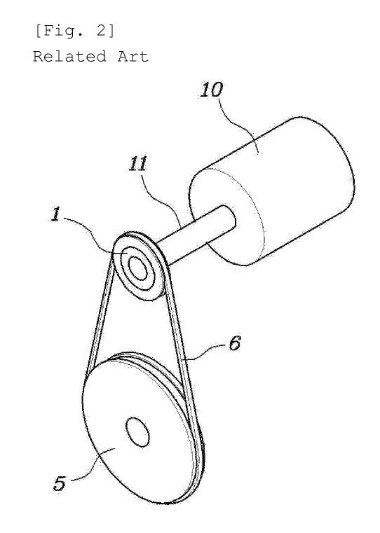

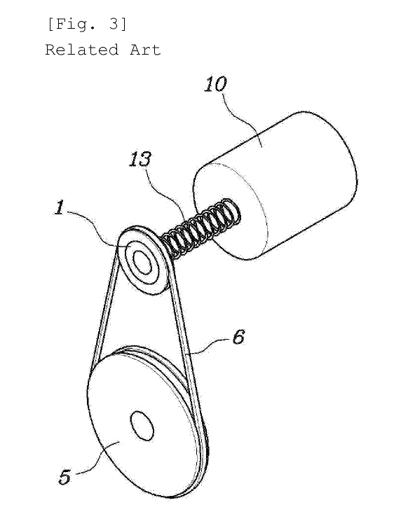

The alternator is configured to be driven by power supplied from the crank shaft. FIG. 4 schematically illustrates that the alternator pulley 40 and the crank shaft pulley 52 are connected to each other by the belt 51. FIG. 1 illustrates a structure in which a water pump pulley, an air conditioner pulley, a power steering pulley, etc., are connected to one another by a belt.

The damper apparatus for an alternator pulley includes a mass inertia body 60 disposed on a same axis as an alternator shaft 31 while being positioned at a front side of the alternator pulley 40, and an elastic mechanism connecting the alternator pulley 40 and the mass inertia body 60 and configured to deliver an inertial rotating force of the mass inertia body 60 to the alternator pulley 40 while delivering the rotating force of the alternator pulley 40 to the mass inertia body 60.

The damper apparatus further includes a bearing 70 installed between the alternator pulley 40 and the mass inertia body 60.

The bearing 70 serves to regulate an installation position of the mass inertia body 60 and to block delivery of the rotating forces between the alternator pulley 40 and the mass inertia body 60. A thrust ball bearing, a needle thrust bearing, a metal bearing, etc., may be used as the bearing 70.

If the alternator pulley 40 and the mass inertia body 60 are not connected to each other by the elastic mechanism (coil spring to be described below), but are connected to each other only by the bearing 70, the rotating forces are not delivered between the alternator pulley 40 and the mass inertia body 60, and therefore the alternator pulley 40 and the mass inertia body 60 rotate relatively to each other.

The mass inertia body 60 has a structure in which a rotating center and a mass center coincide with each other, and is installed in a structure in which an axial center of the alternator shaft 31 and a rotating center of the mass inertia body 60 coincide with each other.

That is, the alternator shaft 31 penetrates through the rotating center of the alternator pulley 40, and an end of the alternator shaft 31 penetrating through the alternator pulley 40 is coupled with a nut 32 to couple the alternator pulley 40 with the alternator shaft 31, such that the alternator pulley 40 may rotate without eccentricity, thereby preventing vibrations and noises from occurring.

The mass inertia body 60 is installed so that the rotating center of the mass inertia body 60 and the axial center of the alternator shaft 31 coincide with each other on the same axis, such that the mass inertia body 60 may also rotate without eccentricity, thereby preventing the vibrations and the noises from occurring.

As described above, the mass inertia body 60 installed on the same axis as the alternator pulley 40 is used to absorb and reduce the vibrations occurring due to the resonance of the alternator to reduce the noises, reduce the slip of the belt 51 due to the absorption and reduction of the vibration, and reduce the belt tension due to the reduction in the slip of the belt 51, thereby improving the fuel efficiency.

A front surface of the alternator pulley 40 is provided with a concave groove 41. Some of the mass inertia body 60 is inserted into the concave groove 41. The bearing 70 is installed between an inner circumferential surface of the concave groove 41 and an outer circumferential surface of the mass inertia body 60 inserted into the concave groove 41.

The concave groove 41 may have a shape in which a cross section of the groove is formed in a circle, but the shape of the concave groove is not limited thereto.

The mass inertia body 60 includes an adaptor 61, inserted into the concave groove 41 to be connected to the alternator pulley 40 by the bearing 70 and coupled with one end of the elastic mechanism, and a mass body 62 coupled with a front of the adaptor 61.

The adaptor 61 and the mass body 62 are coupled with each other by a plurality of bolts 53, but the present disclosure is not limited thereto.

The elastic mechanism according to the present disclosure may be a torsion spring 80.

As the torsion spring 80 is inserted into the concave groove 41, and one end thereof is fixedly coupled with a side surface (i.e. a surface toward the alternator) of the concave groove 41, the torsion spring 80 is coupled with the alternator pulley 40, and the other end of torsion spring 80 is fixedly coupled with the side surface (i.e. a surface toward the mass body) of the adaptor 61.

Hereinafter, an operation of an exemplary form of the present disclosure will be described.

If the belt 51 connected to the crank shaft pulley 52 is driven by the operation of the engine, the alternator 30 is driven by the rotation of the alternator pulley 40 to produce power.

If the alternator pulley 40 rotates, the mass inertia body 60 connected by the torsion spring 80, rotates together with the alternator pulley 40.

When a difference between a rotating speed of the belt 51 and a rotating speed of the alternator shaft 31 occurs due to the driving conditions of the engine, the alternator pulley 40 causes vibrations and noises due to the resonance of the alternator 30 within a specific frequency domain.

In this case, the mass inertia body 60 applies a counter-torque to the alternator pulley 40 through the torsion spring 80, such that the rotating speed of the belt 51 and the rotating speed of the alternator shaft 31 are the same, and the alternator pulley 40 may absorb the vibrations occurring due to the resonance of the alternator 30, thereby removing the noise.

Further, if the vibrations occurring due to the resonance of the alternator 30 are removed by the mass inertia body 60, the stable driving state of the alternator 30 is secured, such that the slip phenomenon of the belt 51 may be reduced and the tension of the belt may be reduced due to the reduction in the slip of the belt 51, thereby improving the fuel efficiency.

According to exemplary forms of the present disclosure, the vibrations occurring due to the resonance of the alternator may be absorbed and reduced by using the mass inertia body installed on the same axis as the alternator pulley, to reduce noise, reduce the slip of the belt due to the absorption and reduction of the vibration, and reduce the belt tension due to the reduction in the slip of the belt, thereby improving the fuel efficiency.

Although the present disclosure has been shown and described with respect to specific exemplary forms, it will be obvious to those skilled in the art that the present invention may be variously modified and altered without departing from the spirit and scope of the present disclosure as defined by the following claims.

What is claimed is:

1. A damper apparatus for an alternator pulley, comprising:
a mass inertia body configured to be disposed on a same axis as an alternator shaft while being positioned at a front side of the alternator pulley; and
an elastic mechanism configured to connect the alternator pulley and the mass inertia body and to deliver an inertial rotating force of the mass inertia body to the alternator pulley while delivering a rotating force of the alternator pulley to the mass inertia body.

2. The damper apparatus of claim 1, further comprising a bearing configured to:
be installed between the alternator pulley and the mass inertia body;
regulate an installation position of the mass inertia body; and
block delivery of the rotating forces between the alternator pulley and the mass inertia body.

3. The damper apparatus of claim 2, wherein a rotating center of the mass inertia body and a mass center of the mass inertia body coincide with each other, and an axial center of the alternator shaft and the rotating center of the mass inertia body are configured to coincide with each other.

4. The damper apparatus of claim 2, wherein a front surface of the alternator pulley is provided with a concave groove, some of the mass inertia body is configured to be inserted into the concave groove, and the bearing is configured to be installed in the concave groove between an inner circumferential surface of the concave groove and an outer circumferential surface of the mass inertia body.

5. The damper apparatus of claim 4, wherein the mass inertia body includes:
an adaptor configured to be inserted into the concave groove to be connected to the alternator pulley by the bearing and coupled with one end of an elastic mechanism; and
a mass body configured to be coupled with a front of the adaptor.

6. The damper apparatus of claim 5, wherein the elastic mechanism is a torsion spring configured to have a first end coupled with the alternator pulley and a second end coupled with the adaptor.

7. The damper apparatus of claim 1, wherein the alternator shaft penetrates through a rotating center of the alternator pulley, and an end of the alternator shaft penetrating through the alternator pulley is coupled with a nut to couple the alternator pulley with the alternator shaft.
